(19) United States
(12) Patent Application Publication
(10) Pub. No.: US 2022/0046666 A1
(43) Pub. Date: Feb. 10, 2022

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Shohei Yoshioka, Tokyo (JP); Lihui Wang, Beijing (CN); Xiaolin Hou, Beijing (CN)

(73) Assignee: NTT DOCOMO, INC., Tokyo (JP)

(21) Appl. No.: 17/280,653

(22) PCT Filed: Sep. 28, 2018
(86) PCT No.: PCT/JP2018/036531

§ 371 Date: Mar. 26, 2021

(51) Int. Cl. H04W 72/12; H04W 72/14

(52) U.S. Cl. CPC H04W 72/1268; H04W 72/14

(57) ABSTRACT

In order to appropriately perform communication even in a case where configured grant-based UL transmission is configured, a user terminal according to an aspect of the present disclosure has a transmitting section that transmits a Uplink Shared Channel by using a resource used for configured grant-based UL transmission, and a control section that cancels transmission of a configured grant-based Uplink Shared Channel using the resource in units of a given frequency domain based on information instructed by Downlink Control Information.

### TECHNICAL FIELD

The present disclosure relates to a user terminal and a radio communication method in a next-generation mobile communication system.

### BACKGROUND ART

For a universal mobile telecommunications system (UMTS) network, the specifications of long-term evolution (LTE) have been drafted for the purpose of higher speed data rates, low latency, or the like (refer to Non Patent Literature 1). Furthermore, the specifications of LTE-A (LTE Advanced, also referred to as LTE Rel. 10, 11, or 12) have been drafted for the purpose of achieving a wider bandwidth and faster speed than a bandwidth and speed for LTE (which is also referred to as LTE Rel. 8 or 9). LTE successor systems (which is also referred to as, for example, Future Radio Access (FRA), 5th generation mobile communication system (5G), 5G+ (plus), New Radio (NR), New radio access (NX), Future generation radio access (FX), LTE Rel. 13, 14, or 15 or later, or the like) are also under study.

In an existing LTE system (for example, LTE Rel. 8 to 13), an uplink signal is mapped to an appropriate radio resource and transmitted from the UE to an eNB. Uplink user data is transmitted by using a Uplink Shared Channel (PUSCH). Furthermore, Uplink Control Information (UCI) is transmitted by using a PUSCH when transmitted together with uplink user data, and by using a Physical Uplink Control Channel (PUCCH) when transmitted individually.

Furthermore, in an existing LTE system, for transmission of a Uplink Shared Channel (PUSCH), a DeModulation Reference Signal (DMRS) of the channel is transmitted.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, New Radio), dynamic grant-based transmission and configured grant-based transmission are under study for UL transmission.

Furthermore, in a case where the UE performs configured grant-based transmission, the UE performs configured grant base using a radio resource configured from a base station. From a viewpoint of radio resource utilization efficiency, it is conceivable that a radio resource used for configured grant-based transmission is also used for dynamic grant-based transmission.

However, with a configuration in which the same radio resource is applicable to both dynamic grant-based transmission and configured grant-based transmission, it becomes a problem how to control the configured grant-based transmission, or like using the radio resource.

Therefore, an object of the present disclosure is to provide a user terminal and a radio communication method capable of appropriately communicating even in a case where configured grant-based UL transmission is configured.

### Solution to Problem

The user terminal according to an aspect of the present disclosure has a transmitting section that transmits a Uplink Shared Channel by using a resource used for configured grant-based UL transmission, and a control section that cancels transmission of a configured grant-based Uplink Shared Channel using the resource in units of a given frequency domain based on information instructed by Downlink Control Information.

### Advantageous Effects of Invention

According to an aspect of the present disclosure, communication can be appropriately performed even in a case where configured grant-based UL transmission is configured.

### BRIEF DESCRIPTION OF DRAWINGS

FIG. 1 is a diagram for describing cancellation of PUSCH transmission using a configured grant-based resource.

FIG. 2 is a diagram for describing a resource used for transmission of a configured grant base in units of subbands in a first aspect of the present invention.

FIG. 3 is a diagram illustrating an example of a correspondence of subbands between different BWPs in the first aspect of the present invention.

FIG. 4 is a diagram illustrating another example of a correspondence of subbands between different BWPs in the first aspect of the present invention.

FIG. 5 is a diagram for describing an example of Listen Before Talk (LBT)-based transmission according to a second aspect of the present invention.

FIG. 6 is a diagram for describing another example of LBT-based transmission according to a second aspect of the present invention.

FIG. 7 is a diagram illustrating an example of a schematic configuration of a radio communication system according to an embodiment.

FIG. 8 is a diagram illustrating an example of a configuration of a base station according to an embodiment.

FIG. 9 is a diagram illustrating an example of a configuration of a user terminal according to an embodiment.

FIG. 10 is a diagram illustrating an example of a hardware configuration of a base station and user terminal according to an embodiment.

### DESCRIPTION OF EMBODIMENTS

<Dynamic grant-based transmission and configured grant-based transmission (Type 1, type 2)>

Dynamic grant-based transmission and configured grant-based transmission are under study for UL transmission of New Radio.

Dynamic grant-based transmission is a method for performing UL transmission by using a Uplink Shared Channel (PUSCH) based on a dynamic UL grant (dynamic grant).

The configured grant-based transmission is a method for performing UL transmission by using a Uplink Shared Channel (PUSCH) based on a UL grant configured by a higher layer (which may also be referred to as a configured grant, configured UL grant, or the like, for example). In the configured grant-based transmission, a UL resource is already allocated to the UE, and the UE can voluntarily perform UL transmission by using a configured resource, and therefore, implementation of low latency communication can be expected.

Dynamic grant-based transmission may also be referred to as dynamic grant-based PUSCH, UL Transmission with dynamic grant, PUSCH with dynamic grant, UL Transmission with UL grant, UL grant-based transmission, UL transmission scheduled (transmission resource-configured) by dynamic grant, or the like.

Configured grant-based transmission may also be referred to as configured grant-based PUSCH, UL Transmission with configured grant, PUSCH with configured grant, UL Transmission without UL grant, UL grant-free transmission, UL transmission scheduled (transmission resource-configured) by configured grant, or the like.

Furthermore, configured grant-based transmission may be defined as one type of UL Semi-Persistent Scheduling (SPS). In the present disclosure, “configured grant” may be replaced with “SPS”, “SPS/configured grant”, or the like.

Several types (type 1, type 2, or the like) have been considered for configured grant-based transmission.

In configured grant type 1 transmission, a parameter used for configured grant-based transmission (which may also be referred to as a configured grant-based transmission parameter, a configured grant parameter, or the like) is configured to the UE by using only higher layer signaling.

In configured grant type 2 transmission, a configured grant parameter is configured to the UE by higher layer signaling. In the configured grant type 2 transmission, at least a part of a configured grant parameter may be notified to the UE by physical layer signaling (for example, Downlink Control Information (DCI) for activation described later).

Here, the higher layer signaling may be, for example, any one of Radio Resource Control (RRC) signaling, Medium Access Control (MAC) signaling, broadcast information, or the like, or a combination of these.

For MAC signaling, for example, a MAC Control Element (MAC CE), a MAC Protocol Data Unit (PDU), or the like may be used. The broadcast information may be, for example, a Master Information Block (MIB), a System Information Block (SIB), Remaining Minimum System Information (RMSI), Other System Information (OSI), or the like.

A configured grant parameter may be configured to the UE by using a ConfiguredGrantConfig information element of RRC. A configured grant parameter may include information specifying configured grant resource, for example. A configured grant parameter may include information related to, for example, an index of a configured grant, time offset, periodicity, the number of repeated transmissions of a Transport Block (TB) (the number of repeated transmissions may be expressed as K), a Redundancy Version (RV) sequence used in repeated transmissions, the above-described timer, or the like.

Here, periodicity and time offset may be represented in units of symbols, slots, subframes, frames, or the like. The periodicity may be indicated by, for example, a given number of symbols. Time offset may be indicated by an offset with respect to timing of a given index (slot number=0 and/or system frame number=0, or the like, for example). The number of repeated transmissions may be any integer, for example, 1, 2, 4, 8, or the like. In a case where the number of repeated transmissions is n (>0), the UE may perform configured grant-based PUSCH transmission of a given TB by using n times of transmission occasions.

The UE may determine that one or a plurality of configured grants have been triggered in a case where the configured grant type 1 transmission is configured. The UE may perform PUSCH transmission by using configured resource for configured grant-based transmission (which may also be referred to as a configured grant resource, a transmission occasion, or the like). Note that even in a case where the configured grant-based transmission is configured, the UE may skip the configured grant-based transmission if there is no data in the transmission buffer.

In a case where the configured grant type 2 transmission is configured and a given activation signal is notified, the UE may determine that one or a plurality of configured grants have been triggered (or activated). The given activation signal (DCI for activation) may be DCI (PDCCH) scrambled by a Cyclic Redundancy Check (CRC) with a given identifier (for example, Configured Scheduling RNTI (CS-RNTI)). Note that the DCI may be used for control such as deactivation, retransmission, or the like of the configured grant.

Based on the above-described given activation signal, the UE may determine whether or not to perform PUSCH transmission by using a configured grant resource configured in a higher layer. Based on the DCI for releasing a configured grant or on the expiration (elapse of a given time) of a given timer, the UE may release (which may also be referred to as deactivate, or the like) a resource (PUSCH) corresponding to the configured grant.

Note that even in a case where the configured grant-based transmission is activated (in an active state), the UE may skip the configured grant-based transmission if there is no data in the transmission buffer.

Note that each of the dynamic grant and configured grant may be referred to as an actual UL grant. That is, an actual UL grant may be higher layer signaling (for example, a ConfiguredGrantConfig information element of RRC), physical layer signaling (for example, the above-described given activation signal), or a combination of these.

Furthermore, up to one configured grant-based PUSCH transmission may be configured to a Band Width Part (BWP) configured to each serving cell.

As described above, in a case where there is data in a transmission buffer, the UE performs configured grant-based PUSCH transmission by using a configured grant-based resource. Therefore, from a viewpoint of improving radio resource utilization efficiency, it is conceivable that the configured grant-based resource is also used as, for example, a grant-based transmission resource (grant-based resource) in another UE.

In such a case, in a resource capable of both grant-based transmission and configured grant-based transmission (for example, a PUSCH resource), transmission timing of a configured grant-based PUSCH and transmission timing of a PUSCH scheduled by DCI may conflict with each other. In a case where a conflicting PUSCH cannot be transmitted, resource utilization efficiency may decrease. Furthermore, UL transmission may be delayed and communication quality may deteriorate.

In order to avoid such a conflict between configured grant-based UL transmission and dynamic grant-based UL transmission, the present inventors have focused on the fact that configured grant-based UL transmission (for example, PUSCH transmission) can be cancelled by using a given signal.

Note that, here, cancellation of configured grant-based UL transmission (for example, PUSCH transmission) is interpreted as that configured grant-based UL transmission (for example, PUSCH transmission) that has started transmission is stopped before the UL transmission is completed. Furthermore, stopping transmission may mean that transmission power is reduced to zero or the transmission power is significantly lowered as compared to the UL transmission. Transmission power at which transmission is determined to be stopped may be, for example, a value less than Minimum output power (for example, −40 dBm) or a value defined as OFF power (for example, −50 dBm) or less.

For example, in New Radio, it is assumed that information related to format of each slot is notified from the base station to the UE by using Downlink Control Information. A slot format is notified to the UE by using a given field (which is also referred to as SFI, for example) included in Downlink Control Information.

In a slot in which a configured slot format (for example, a slot format specified from the base station) is DL or flexible, the UE performs control so that UL transmission using a configured grant-based resource is not performed (for example, cancelled).

A case is assumed where a network (for example, a base station) wishes to apply the configured grant-based resource to dynamic grant-based UL transmission (for example, UL transmission of another UE) in a given slot to which a configured grant-based resource is configured. In such a case, the base station notifies the UE to which a configured grant-based resource is configured that a slot format of a given slot by using Downlink Control Information (for example, SFI) is DL or flexible.

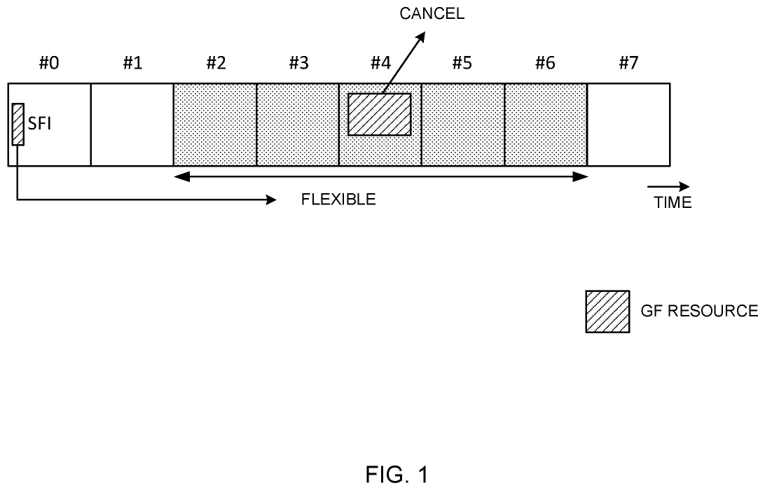

The UE notified of the SFI from the base station cancels PUSCH transmission using a configured grant-based resource in the given slot (refer to FIG. 1). FIG. 1 illustrates a case where the SFI transmitted in a slot #0 notifies the UE that slots #2 to #6 are flexible or DL.

In this case, the UE controls not to perform (for example, cancel) configured grant-based UL transmission using a configured grant-based resource configure in the slot #4. Note that, because transmission using a first activated resource among resources for a configured grant base of type 2 is treated as UE-specific data, control may be performed so that the first activated resource is not cancelled.

Furthermore, to another UE, the base station schedules a dynamic grant-based PUSCH using the same resource as the configured grant-based resource in the given slot. The another UE to which PUSCH transmission is scheduled from the base station performs PUSCH transmission by using the resource.

Thus, it is possible to cancel configured grant-based PUSCH transmission in the UE to which a configured grant-based resource is configured by notification of downlink Control Information from the base station, and to use the configured grant-based resource for dynamic grant-based PUSCH transmission. With this arrangement, even in a case where a common resource is used for dynamic grant-based UL transmission and configured grant-based UL transmission, a conflict in UL transmission can be avoided, and therefore resource utilization efficiency can be improved.

Meanwhile, in a case where configured grant-based UL transmission is cancelled, the configured grant-based UL transmission cannot be performed. For example, in a case of FIG. 1, the SFI transmitted in a slot #0 notifies the UE that slots #2 to #6 are flexible or DL, and therefore, transmission of a configured grant base cannot be performed in the slots #2 to #6. In such a case, there may be a delay in the transmission of a configured grant base.

Therefore, the present inventors have focused on the fact that cancellation of PUSCH transmission using SFI, which is currently assumed, is performed over an entire band allocated to a user terminal, have found that configured grant-based UL transmission can be appropriately performed without delay, and have conceived of the present invention.

That is, the user terminal according to an aspect of the present invention transmits a Uplink Shared Channel using a resource used for configured grant-based UL transmission, and cancels transmission of a configured grant-based Uplink Shared Channel using the resource in units of a given frequency domain based on information instructed by Downlink Control Information.

Hereinafter, an embodiment according to the present disclosure will be described in detail with reference to the drawings. Configurations described in each of the aspects may be applied individually or in combination.

### (First Aspect)

In a first aspect, a resource used for transmission of a configured grant base is configured in units of a given frequency domain (which is also referred to as a subband), and the transmission of the configured grant base is cancelled in units of the given frequency domain (cancellation of UL transmission/DL reception). With this arrangement, a plurality of configured grant bases can be configured in a frequency resource in a Band Width Part (BWP) or a cell.

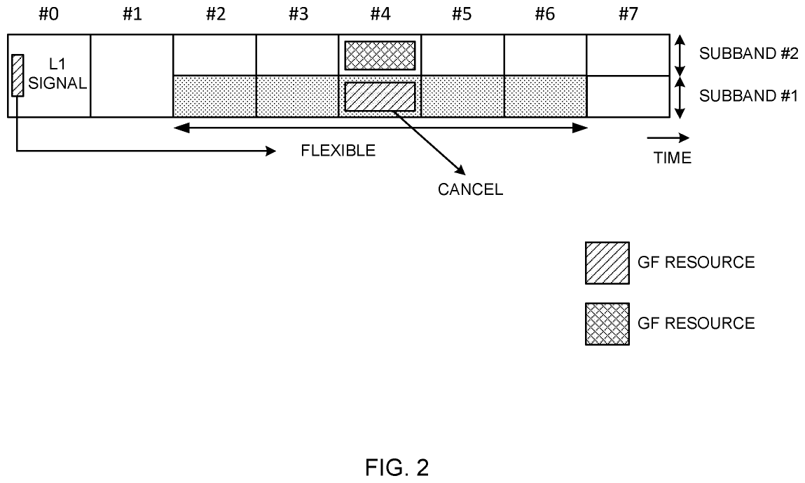

FIG. 2 is a diagram for describing a resource used for transmission of a configured grant base in units of subbands in a first aspect of the present invention.

In FIG. 2, the base station notifies, by using downlink Control Information (for example, an L1 signal in FIG. 2), to the UE to which a configured grant-based resource is configured, in a slot #4 to which a configured grant-based resource is configured, that a slot format of the slot #4 is DL or flexible.

At this time, the base station configures a resource used for transmission of a configured grant base in units of a frequency domain (subband). In FIG. 2, two subbands are configured, and transmission of configured grant-based PUSCH for a subband #1 is canceled by the L1 signal. At this time, for the slot #4 of a subband #2, a state where configured grant-based resource is configured is maintained.

Therefore, a configured grant-based UE can perform configured grant-based PUSCH transmission by using the slot #4 of the subband #2. With this arrangement, the configured grant-based UE can appropriately perform configured grant-based UL transmission.

A fact that a slot format of a given slot is DL or flexible (information indicating the slot format in a time domain) may be specified by Downlink Control Information (DCI). In this case, SFI (for example, DCI format 2_0) specified as of the time of filing the application may be used as Downlink Control Information to further notify of subband information, and Downlink Control Information that including at least information indicating a slot format in a time domain and subband information may be used.

In a case where Downlink Control Information specifies that a slot format of a given slot is DL or flexible, the UE is configured to monitor the Downlink Control Information. Furthermore, a slot format of a given slot (DL, UL, flexible domain pattern of one or a plurality slots) for a subband is configured by higher layer signaling. This configuration also includes a position and size of a subband frequency domain. The position or size of the frequency domain of the subband may be indicated by a starting position or length of consecutive Resource blocks (RBs) having a reference Subcarrier Spacing (SCS) used as a reference.

At least one of a position and size of a given frequency domain may be configured based on at least one of for each Band Width Part (BWP), for each cell, or for each user terminal. A BWP is one or more frequency bands within a carrier (which is also referred to as a Component Carrier (CC) or system band). In order to reduce processing load in the UE (for example, processing load by blind decoding of each of the frequency bands), it is desired to appropriately control activation and/or deactivation of the frequency bands. In this case, there are three methods.

### <Method 1>

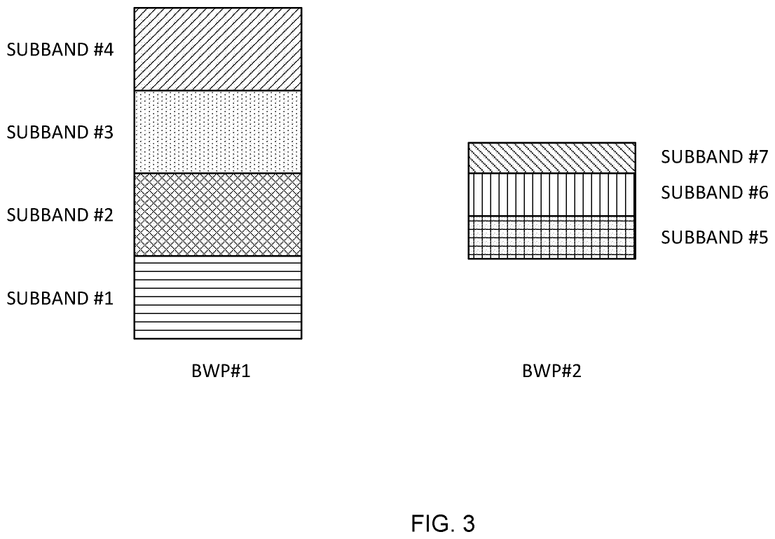

In a case where at least one of a position and size of a given frequency domain is configured for each BWP or for each cell, a position or size of a given frequency domain configured to a changed BWP according to a change in the BWP is applied. For example, as illustrated in FIG. 3, subbands #1 to #4 are configured before a BWP change, and after the BWP change, subbands #5 to #7 different in position or size as compared to before the BWP change are configured. With such a configuration, it is possible to reduce signaling overhead, because configuration of a position or size of the given frequency domain for each BWP is not necessary.

### <Method 2>

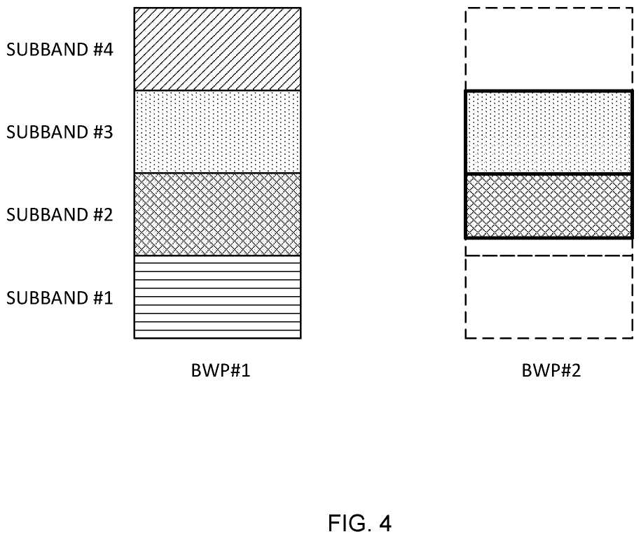

In a case where at least one of a position and size of a given frequency domain is configured for each cell, a position or size of a frequency domain common between before and after a change in the BWP is applied. For example, as illustrated in FIG. 4, even in a case where a BWP after a BWP change is smaller in size than a BWP before the BWP change, positions or sizes of the subbands #1 to #4 are common. This is similar as in a case where a BWP after a BWP change is larger in size than a BWP before the BWP change With such a configuration, a configuration always based on a reference SCS can be implemented.

### <Method 3>

In a case where at least one of a position and size of a given frequency domain is configured for each UE, a position or size of a frequency domain common in one or more component carriers is applied. For example, as illustrated in FIG. 4, even in a case where a BWP after a BWP change is smaller in size than a BWP before the BWP change, positions or sizes of the subbands #1 to #4 are common. In the present aspect, in a case where an added component carrier or an activated component carrier is configured, transmission of a configured grant base is cancelled in units of subbands according to the present aspect. With this arrangement, a subband can be configured over a plurality of component carriers, and a subband can be configured for each component carrier.

In the present aspect, an L1 signal (downlink Control Information) illustrated in FIG. 2 cancels transmission of a configured grant base in units of subbands according to the present aspect in a case where a period up to a slot #4 to which a configured grant-based resource is configured exceeds required processing time (T_proc_1), that is, in a case where the L1 signal is received with respect to a configured grant-based resource configured in the L1 signal before the processing time (T_proc_1).

Although an example illustrated in FIG. 2 describes a case where a slot format of a given slot is flexible, the present aspect can be similarly applied to a case where a slot format of a given slot is DL.

In a case where a slot format of a given slot is DL, when SFI is used as an L1 signal for example, configuration is made such that a configured grant-based UE monitors the SFI and acquires information of the slot format of the given slot with the SFI, and a dynamic grant-based UE does not monitor the SFI. In such a configuration, a PUSCH is allocated to a dynamic grant-based UE to the given slot. Note that a target to be configured to be monitored by a configured grant-based UE and not monitored by a dynamic grant-based UE is not limited to SFI, and may be another signal (Downlink control signal, or the like).

Although a case where there are two subbands is illustrated in FIG. 2, the present aspect can be similarly applied to a case where there are three or more subbands. A priority of subbands to a slot format (cancellation interval) of a given slot is applied may be determined based on a subband number (index) (ascending or descending order), or the base station may notify the User terminal of a subband number (index).

### (Second Aspect)

A second aspect describes UL transmission control (for example, cancellation, or the like) in a case where listening (which is also referred to as LBT) is applied to a configured grant-based UL transmission and a dynamic grant-based UL transmission.

### <Method 1>

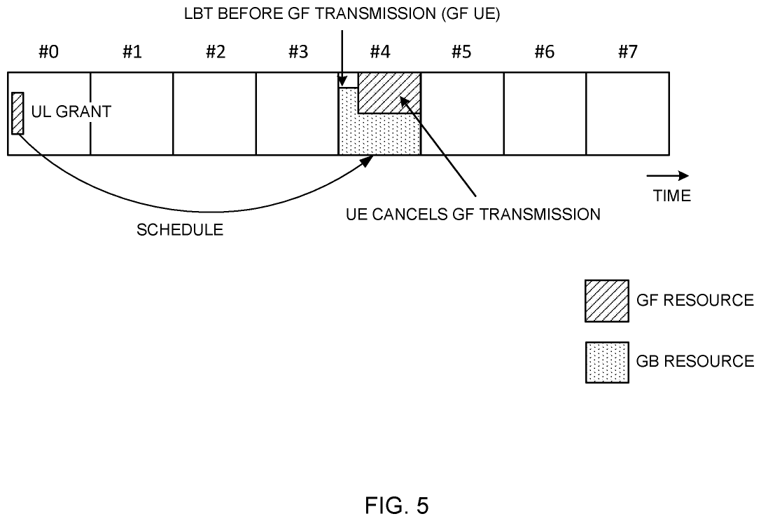

Method 1 is a method for supporting LBT-based transmission to a configured grant-based UE (GF UE). In Method 1, in a case where a configured grant-based resource is configured in a given slot (a slot #4 in FIG. 5), LBT is performed before the configured grant-based UE transmits a PUSCH signal, and, if a channel is clear, performs configured grant-based UL transmission. In this case, in a case where the base station schedules dynamic grant-based UL transmission, a resource of dynamic grant-based UL transmission is configured at a position timewise before a starting position of a configured grant-based resource.

At this time, in a case where LBT is performed, the configured grant-based UE cancels configured grant-based UL transmission when recognizing a dynamic grant-based PUSCH (when the transmission power exceeds the threshold value), and performs configured grant-based UL transmission when not recognizing a dynamic grant-based PUSCH (channel clear). With this arrangement, a conflict in UL transmission can be avoided, while resource utilization efficiency can be improved.

### <Method 2>

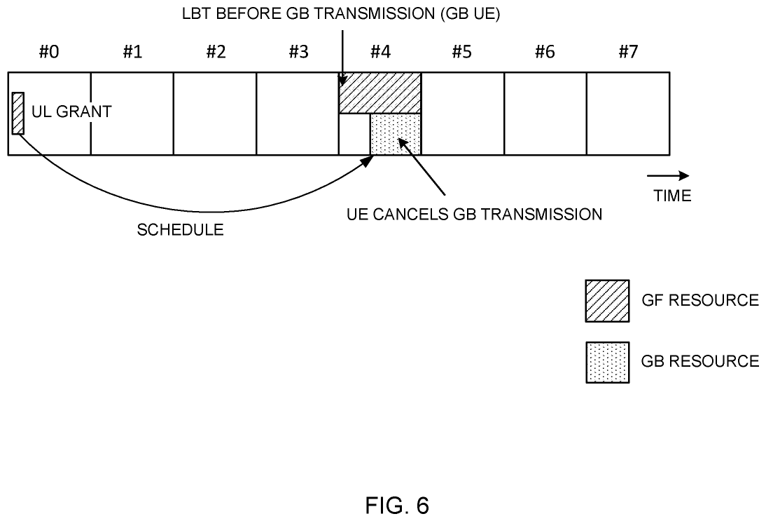

Method 2 is a method for supporting LBT-based transmission to a dynamic grant-based UE (GB UE). In Method 2, in a case where a configured grant-based resource is configured in a given slot (a slot #4 in FIG. 6) and where a dynamic grant-based UE is scheduled to the configured grant-based resource, LBT is performed before the dynamic grant-based UE transmits a PUSCH signal, and, if a channel is clear, performs dynamic grant-based UL transmission. In this case, a resource of configured grant-based UL transmission is configured at a position timewise before a starting position of a dynamic grant-based resource.

At this time, in a case where LBT is performed, the dynamic grant-based UE cancels dynamic grant-based UL transmission when recognizing a configured grant-based PUSCH (when the transmission power exceeds the threshold value), and performs dynamic grant-based UL transmission when not recognizing a configured grant-based PUSCH (channel clear). With this arrangement, a conflict in UL transmission can be avoided, while resource utilization efficiency can be improved.

Note that whether or not to perform LBT when transmitting a configured grant-based PUSCH may be configured by higher layer signaling from the base station. The configuration may be made for each BWP, for each cell, or for each UE.

Furthermore, in a case where a plurality of configuration grant-based PUSCH resources can be configured in the same BWP or cell, whether or not to perform LBT may be configured separately for each of the plurality of configured grant-based PUSCH resources. In this case, highly flexible operation is possible in which a configured grant-based PUSCH resource configured to transmit UL data with high priority is caused not to perform LBT but to perform reliable transmission, and a configured grant-based PUSCH resource configured to transmit UL data with low priority is caused to perform LBT and to stop transmission in a case where there is another transmission.

Alternatively, in a case where a plurality of configuration grant-based PUSCH resources can be configured in the same BWP or cell, whether or not to perform LBT may be configured in common among the plurality of configured grant-based PUSCH resources. In this case, it is possible to reduce overhead of higher layer signaling, because transmission of separate higher layer signaling for each resource of a configured grant base is not necessary.

### (Radio Communication System)

Hereinafter, a configuration of a radio communication system according to an embodiment of the present disclosure will be described. In this radio communication system, communication is performed by using any one of or a combination of the radio communication methods according to the above-described embodiments of the present disclosure.

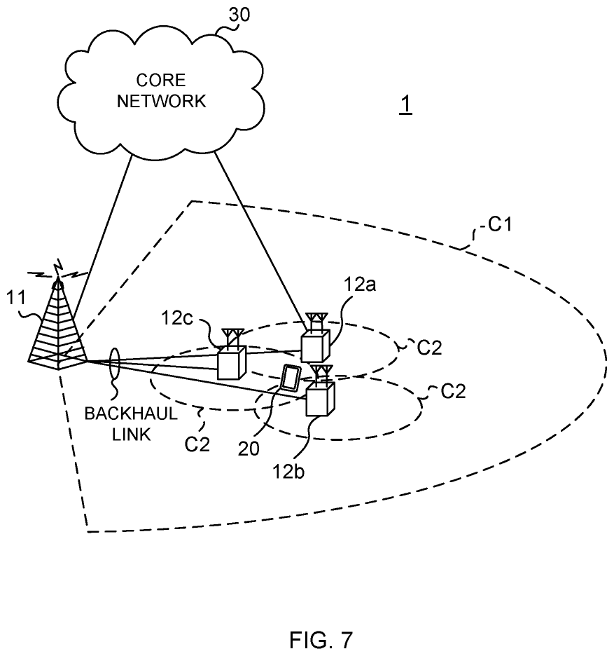

FIG. 7 is a diagram illustrating an example of a schematic configuration of the radio communication system according to an embodiment. A radio communication system 1 may be a system that implements communication using Long Term Evolution (LTE), 5th generation mobile communication system New Radio (5G New Radio), or the like specified by Third Generation Partnership Project (3GPP).

Furthermore, the radio communication system 1 may support dual connectivity (Multi-RAT Dual Connectivity (MR-DC)) between a plurality of Radio Access Technologies (RATs). The MR-DC may include dual connectivity between LTE (Evolved Universal Terrestrial Radio Access (E-UTRA)) and New Radio (E-UTRA-NR Dual Connectivity (EN-DC)), dual connectivity between New Radio and LTE (NR-E-UTRA Dual Connectivity (NE-DC)), or the like.

In the EN-DC, an E-UTRA (LTE) base station (eNB) is a Master Node (MN), and a New Radio base station (gNB) is a Secondary Node (SN). In the NE-DC, a New Radio base station (gNB) is an MN, and an E-UTRA (LTE) base station (eNB) is an SN.

The radio communication system 1 may support dual connectivity between a plurality of base stations in the same RAT (for example, dual connectivity in which both an MN and an SN are New Radio base stations (gNB) (NR-NR dual connectivity (NN-DC)).

The radio communication system 1 may include a base station 11 that forms a Macro cell C1 with a relatively wide coverage, and base stations 12 (12a to 12c) disposed in the Macro cell C1, each of which forms a Small cell C2 narrower than the Macro cell C1. A user terminal 20 may be positioned in at least one cell. Disposition, number, and the like of each of the cells and the user terminal 20 are not limited to the aspects illustrated in the drawings.

Hereinafter, the base stations 11 and 12 will be collectively referred to as a “base station 10”, unless these base stations are distinguished from each other.

The user terminal 20 may be connected to at least one of a plurality of base stations 10. The user terminal 20 may use at least one of a Carrier Aggregation and dual connectivity (DC) using a plurality of Component Carriers (CCs).

Each of the CCs may be included in at least one of a Frequency Range 1 (FR1) and a Frequency Range 2 (FR2). The Macro cell C1 may be included in the FR1, and the Small cell C2 may be included in the FR2. For example, the FR1 may be a frequency range of 6 GHz or less (sub-6 GHz), and the FR2 may be a frequency range higher than 24 GHz (above-24 GHz). Note that frequency ranges, definitions, or the like of the FR1 and FR2 are not limited to these, and, for example, the FR1 may correspond to a higher frequency range than the FR2.

Furthermore, the user terminal 20 may perform communication in each of the CCs by using at least one of Time Division Duplex (TDD) or Frequency Division Duplex (FDD).

The plurality of base stations 10 may be connected by wire (for example, an optical fiber, X2 interface, or the like compatible with Common Public Radio Interface (CPRI)) or wirelessly (for example, New Radio communication). For example, in a case where New Radio communication is used as a backhaul between the base stations 11 and 12, the base station 11 corresponding to a higher-level station may also be referred to as an Integrated Access Backhaul (IAB) donor, and a base station 12 corresponding to a relay station (relay) may also be referred to as an IAB node.

A base station 10 may be connected to a core network 30 via another base station 10 or directly. The core network 30 may include, for example, at least one of an Evolved Packet Core (EPC), a 5G Core Network (5GCN), a Next Generation Core (NGC), or the like.

The user terminal 20 may be a terminal corresponding to at least one of communication methods such as LTE, LTE-A, or 5G.

In the radio communication system 1, a radio access method based on Orthogonal Frequency Division Multiplexing (OFDM) may be used. For example, in at least one of Downlink (DL) and Uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), or the like may be used.

A radio access method may also be referred to as a waveform. Note that, in the radio communication system 1, another radio access method (for example, another single carrier transmission method or another multi-carrier transmission method) may be used as a radio access method for the UL or the DL.

In the radio communication system 1, as a downlink channel, a Physical Downlink Shared Channel (PDSCH) shared by each of the user terminals 20, a Physical Broadcast Channel (PBCH), a Physical Downlink Control Channel (PDCCH), or the like may be used.

Furthermore, in the radio communication system 1, as an uplink channel, a Uplink Shared Channel (PUSCH) shared by each of the user terminals 20, a Physical Uplink Control Channel (PUCCH), a Physical Random Access Channel (PRACH), or the like may be used.

The PDSCH may transmit user data, higher layer control information, a System Information Block (SIB), or the like. The PUSCH may transmit user data, higher layer control information, or the like. Furthermore, the PBCH may transmit Master Information Block (MIB).

The PDCCH may transmit lower layer control information. The lower layer control information may include, for example, Downlink Control Information (DCI) including scheduling information of at least one of PDSCH and PUSCH.

Note that DCI that schedules a PDSCH may also be referred to as DL assignment, DL DCI, or the like, and DCI that schedules a PUSCH may also be referred to as a UL grant, UL DCI, or the like. Note that a PDSCH may be replaced with DL data, and a PUSCH may be replaced with UL data.

A COntrol REsource SET (CORESET) or a Search Space may be used to detect a PDCCH. A CORESET corresponds to a resource that searches for DCI. A Search Space corresponds to a search domain and a search method for PDCCH candidates. One CORESET may be associated with one or a plurality of Search Spaces. The UE may monitor a CORESET associated with a given Search Space based on a Search Space configuration.

One SS may correspond to a PDCCH candidate corresponding to one or a plurality of aggregation levels. One or a plurality of Search Spaces may also be referred to as a Search Space set. Note that “Search Space”, “Search Space set”, “Search Space configuration”, “Search Space set configuration”, “CORESET”, “CORESET configuration”, and the like in the present disclosure may be replaced with one another.

The PUCCH may transmit Channel State Information (CSI), delivery confirmation information (for example, Hybrid Automatic Repeat reQuest (HARQ-ACK), which may also be referred to as ACK/NACK, or the like), a Scheduling Request (SR), or the like. The PRACH may transmit a random access preamble for establishing connection with a cell.

Note that, in the present disclosure, downlink, uplink, or the like may be expressed without “link”. Furthermore, various channels may be expressed without adding “Physical” to the beginning thereof.

In the radio communication system 1, a Synchronization Signal (SS), a Downlink Reference Signal (DL-RS), or the like may be transmitted. In the radio communication systems 1, a Cell-specific Reference Signal (CRS), a Channel State Information Reference Signal (CSI-RS), a DeModulation Reference Signal (DMRS), a Positioning Reference Signal (PRS), a Phase Tracking Reference Signal (PTRS), or the like may be transmitted as a DL-RS.

A synchronization signal may be, for example, at least one of a Primary Synchronization Signal (PSS) or a Secondary Synchronization Signal (SSS). A signal block including an SS (PSS or SSS) and a PBCH (and a DMRS for the PBCH) may also be referred to as an SS/PBCH block, an SSB (SS Block), or the like. Note that an SS, SSB, or the like may also be referred to as a reference signal.

Furthermore, in the radio communication system 1, a Sounding Reference Signal (SRS), a demodulation reference signal (DMRS), or the like may be transmitted as an Uplink Reference Signal (UL-RS). Note that a DMRS may also be referred to as a UE-specific Reference Signal.

### (Base Station)

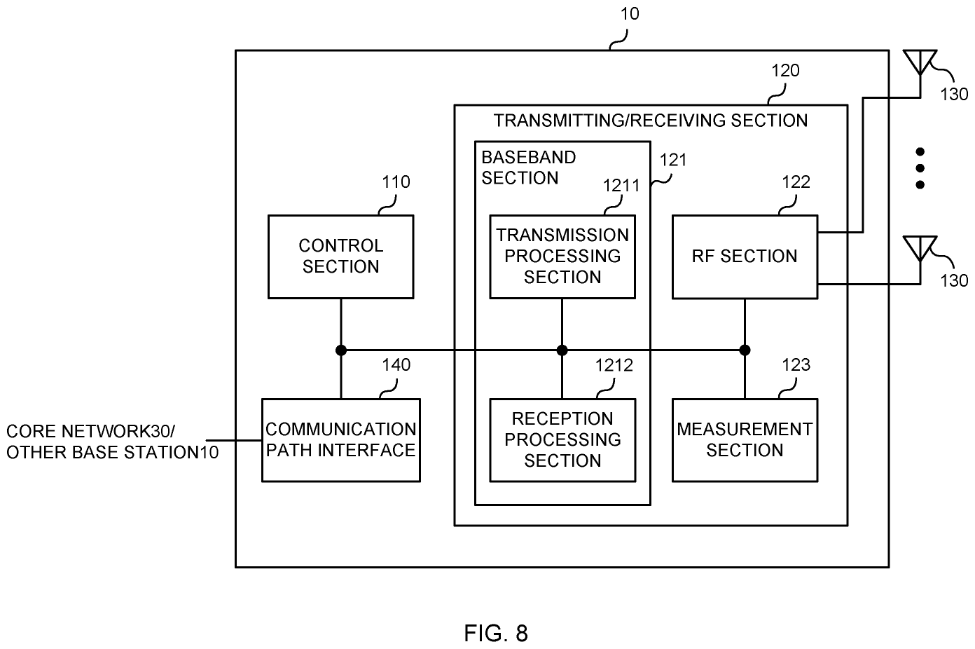

FIG. 8 is a diagram illustrating an example of a configuration of a base station according to an embodiment. The base station 10 includes a control section 110, a transmitting/receiving section 120, a transmission/reception antenna 130, and a communication path interface 140. Note that one or more control sections 110, one or more transmitting/receiving sections 120, one or more transmission/reception antennas 130, and one or more communication path interfaces 140 may be included.

Note that, although this example mainly describes a functional block which is a characteristic part of the present embodiment, the base station 10 may be assumed also to have another functional block that is necessary for radio communication. Part of processing of each unit described below may be omitted.

The control section 110 controls an entire base station 10. The control section 110 can include a controller, a control circuit, or the like, which is described based on common recognition in a technical field according to the present disclosure.

The control section 110 may control signal generation, scheduling (for example, resource allocation or mapping), or the like. The control section 110 may control transmission/reception, measurement, or the like using the transmitting/receiving section 120, the transmission/reception antenna 130, and the communication path interface 140. The control section 110 may generate data to be transmitted as a signal, control information, a sequence, or the like, and transfer the data, the control information, the sequence, or the like to the transmitting/receiving section 120. The control section 110 may perform call processing (such as configuration or releasing) of a communication channel, management of a state of the base station 10, management of a radio resource, or the like.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can include a transmitter/receiver, an RF circuit, a base band circuit, a filter, a phase shifter, a measurement circuit, a transmission/reception circuit, or the like, which is described based on common recognition in a technical field according to the present disclosure.

The transmitting/receiving section 120 may be constituted as an integrated transmitting/receiving section, or may be constituted by a transmitting section and a receiving section. The transmitting section may include the transmission processing section 1211 and the RF section 122. The receiving section may include the reception processing section 1212, the RF section 122, and the measurement section 123.

The transmission/reception antenna 130 can include an antenna, for example, an array antenna, or the like, which is described based on common recognition in a technical field according to the present disclosure.

The transmitting/receiving section 120 may transmit the above-described downlink channel, synchronization signal, Downlink Reference Signal, or the like. The transmitting/receiving section 120 may receive the above-described uplink channel, Uplink Reference Signal, or the like.

The transmitting/receiving section 120 may form at least one of a transmission beam and a reception beam by using digital beam forming (for example, precoding), analog beam forming (for example, phase rotation), or the like.

On data, control information, or the like acquired from the control section 110 for example, the transmitting/receiving section 120 (transmission processing section 1211) may perform processing of a Packet Data Convergence Protocol (PDCP) layer, processing of a Radio Link Control (RLC) layer (for example, RLC retransmission control, processing of a Medium Access Control (MAC) layer (for example, HARQ retransmission control), or the like, and may generate a bit string to be transmitted.

On the bit string to be transmitted, the transmitting/receiving section 120 (transmission processing section 1211) may perform transmission processing such as channel encoding (which may include error correction coding), modulation, mapping, filtering processing, Discrete Fourier Transform (DFT) processing (if necessary), Inverse Fast Fourier Transform (IFFT) processing, precoding, digital-analog conversion, or the like, and may output a baseband signal.

The transmitting/receiving section 120 (RF section 122) may perform modulation to a radio frequency range, filtering processing, amplification, or the like on the baseband signal, and may transmit a signal in the radio frequency band via the transmission/reception antenna 130.

Meanwhile, the transmitting/receiving section 120 (RF section 122) may perform amplification, filtering processing, demodulation to a baseband signal, or the like on the signal in the radio frequency range received by the transmission/reception antenna 130.

To acquire user data, or the like, the transmitting/receiving section 120 (reception processing section 1212) may apply, to the acquired baseband signal, reception processing such as analog-digital conversion, Fast Fourier Transform (FFT) processing, Inverse Discrete Fourier Transform (IDFT) processing (if necessary), filtering processing, demapping, demodulation, decoding (which may include error correction decoding), MAC layer processing, processing of an RLC layer, processing of a PDCP layer, or the like.

The transmitting/receiving section 120 (measurement section 123) may perform measurement related to the received signal. For example, the measurement section 123 may perform Radio Resource Management (RRM) measurement, Channel State Information (CSI) measurement, or the like based on the received signal. The measurement section 123 may measure received power (for example, Reference Signal Received Power (RSRP)), received quality (for example, Reference Signal Received Quality (RSRQ), a Signal to Interference plus Noise Ratio (SINR), a Signal to Noise Ratio (SNR), signal strength (for example, a Received Signal Strength Indicator (RSSI)), propagation path information (for example, CSI), or the like. A measurement result may be output to the control section 110.

The communication path interface 140 may transmit/receive a signal (backhaul signaling) to and from an apparatus included in the core network 30, another base stations 10, or the like, and may acquire, transmit, or the like user data (user plane data), control plane data, or the like for the user terminal 20.

Note that a transmitting section and receiving section of the base station 10 in the present disclosure may include at least one of the transmitting/receiving section 120, the transmission/reception antenna 130, or the communication path interface 140.

Note that transmitting/receiving section 120 transmits, to the user terminal, downlink control information indicating that a slot format of a given slot in units of subbands is DL or flexible. This downlink control information includes SFI or another L1 signal.

### (User Terminal)

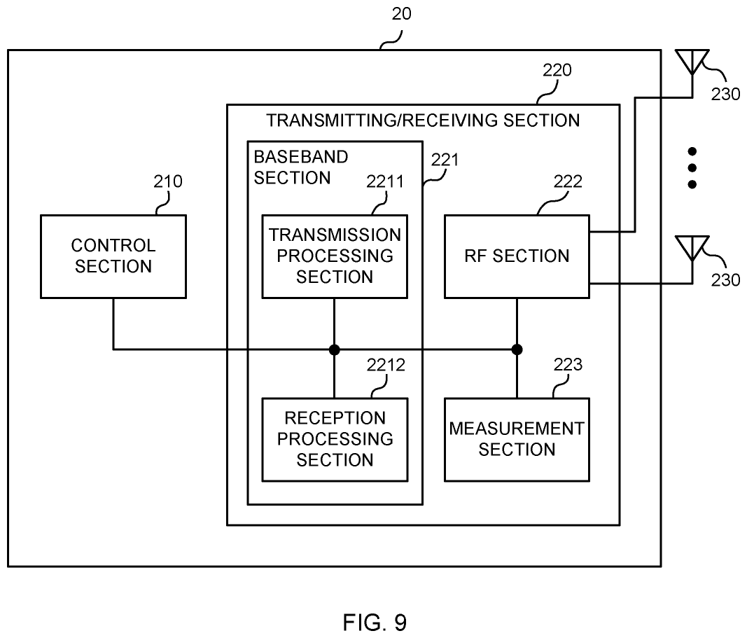

FIG. 9 is a diagram illustrating an example of a configuration of a user terminal according to an embodiment. The user terminal 20 includes a control section 210, a transmitting/receiving section 220, and a transmission/reception antenna 230. Note that one or more control sections 210, one or more transmitting/receiving sections 220, and one or more transmission/reception antennas 230 may be included.

Note that, although this example mainly describes a functional block which is a characteristic part of the present embodiment, the user terminal 20 may be assumed also to have another functional block that is necessary for radio communication. Part of processing of each unit described below may be omitted.

The control section 210 controls an entire user terminal 20. The control section 210 can include a controller, a control circuit, or the like, which is described based on common recognition in a technical field according to the present disclosure.

The control section 210 may control signal generation, mapping, or the like. The control section 210 may control transmission/reception, measurement, or the like using the transmitting/receiving section 220 and the transmission/reception antenna 230. The control section 210 may generate data to be transmitted as a signal, control information, a sequence, or the like, and transfer the data, the control information, the sequence, or the like to the transmitting/receiving section 220.

The transmitting/receiving section 220 may include a baseband section 221, an RF section 222, or a measurement section 223. The baseband section 221 may include a transmission processing section 2211 or a reception processing section 2212. The transmitting/receiving section 220 can include a transmitter/receiver, an RF circuit, a base band circuit, a filter, a phase shifter, a measurement circuit, a transmission/reception circuit, or the like, which is described based on common recognition in a technical field according to the present disclosure.

The transmitting/receiving section 220 may be constituted as an integrated transmitting/receiving section, or may be constituted by a transmitting section and a receiving section. The transmitting section may include the transmission processing section 2211 or the RF section 222. The receiving section may include the reception processing section 2212, the RF section 222, or the measurement section 223.

The transmission/reception antenna 230 can include an antenna, for example, an array antenna, or the like, which is described based on common recognition in a technical field according to the present disclosure.

The transmitting/receiving section 220 may receive the above-described downlink channel, synchronization signal, Downlink Reference Signal, or the like. The transmitting/receiving section 220 may transmit the above-described uplink channel, Uplink Reference Signal, or the like.

The transmitting/receiving section 220 may form at least one of a transmission beam and a reception beam by using digital beam forming (for example, precoding), analog beam forming (for example, phase rotation), or the like.

On data, control information, or the like acquired from the control section 210 for example, the transmitting/receiving section 220 (transmission processing section 2211) may perform processing of a PDCP layer, processing of an RLC layer (for example, RLC retransmission control, processing of an MAC layer (for example, HARQ retransmission control), and may generate a bit string to be transmitted.

On the bit string to be transmitted, the transmitting/receiving section 220 (transmission processing section 2211) may perform transmission processing such as channel encoding (which may include error correction coding), modulation, mapping, filtering processing, DFT processing (if necessary), IFFT processing, precoding, or digital-analog conversion, and may output a baseband signal.

Note that whether or not to apply DFT processing may be determined based on a configuration of transform precoding. In a case where transform precoding is enabled for a given channel (for example, PUSCH), the transmitting/receiving section 220 (transmission processing section 2211) may perform DFT processing as the above-described transmission processing in order to transmit the channel by using a DFT-s-OFDM waveform. In a case where transform precoding is not enabled for a given channel (for example, PUSCH), the transmitting/receiving section 220 (transmission processing section 2211) does not need to perform DFT processing as the above-described transmission processing.

The transmitting/receiving section 220 (RF section 222) may perform modulation to a radio frequency range, filtering processing, amplification, or the like on the baseband signal, and may transmit a signal in the radio frequency band via the transmission/reception antenna 230.

Meanwhile, the transmitting/receiving section 220 (RF section 222) may perform amplification, filtering processing, demodulation to a baseband signal, or the like on the signal in the radio frequency range received by the transmission/reception antenna 230.

To acquire user data, or the like, the transmitting/receiving section 220 (reception processing section 2212) may apply, to the acquired baseband signal, reception processing such as analog-digital conversion, FFT processing, IDFT processing (if necessary), filtering processing, demapping, demodulation, decoding (which may include error correction decoding), MAC layer processing, processing of an RLC layer, processing of a PDCP layer, or the like.

The transmitting/receiving section 220 (measurement section 223) may perform measurement related to the received signal. For example, the measurement section 223 may perform RRM measurement, CSI measurement, or the like based on the received signal. The measurement section 223 may measure received power (for example, RSRP), received quality (for example, RSRQ, an SINR, or an SNR), signal strength (for example, an RSSI), propagation path information (for example, CSI), or the like. A measurement result may be output to the control section 210.

Note that a transmitting section and receiving section of the user terminal 20 in the present disclosure may include at least one of the transmitting/receiving section 220, the transmission/reception antenna 230, or the communication path interface 240.

Note that the transmitting/receiving section 220 transmits a PUSCH signal by using a resource used for configured grant-based UL transmission.

The control section 210 cancels transmission of a configured grant-based PUSCH signal using a resource in units of a given frequency domain (in units of subbands) based on information instructed by the Downlink Control Information In a case where at least one of a position and size of a given frequency domain is configured for each BWP, the control section 210 performs control so as to apply a position or size of a given frequency domain configured to a changed BWP according to a change in the BWP Furthermore, in a case where at least one of a position and size of a given frequency domain is configured for each cell, the control section 210 performs control so as to apply a position or size of a frequency domain common between before and after a change in the BWP.

### (Hardware Configuration)

Note that the block diagrams used to describe the above embodiment illustrate blocks in functional units. These functional blocks (configuration units) may be implemented by any combination of at least one of hardware and software. Furthermore, the method for implementing each of the functional blocks is not particularly limited. That is, each of the functional blocks may be implemented by a single apparatus physically or logically aggregated, or may be implemented by directly or indirectly connecting two or more physically or logically separate apparatuses (by wire or wirelessly, or the like, for example) and using these plural apparatuses. A functional block may be implemented by combination of the one or a plurality of above-described apparatuses with software.

Here, the functions include, but are not limited to, judging, determination, decision, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, assigning, and the like. For example, a functional block (configuration unit) that causes transmission to function may be referred to as a transmitting section, a transmitter or the like. In any case, as described above, the implementation method is not particularly limited.

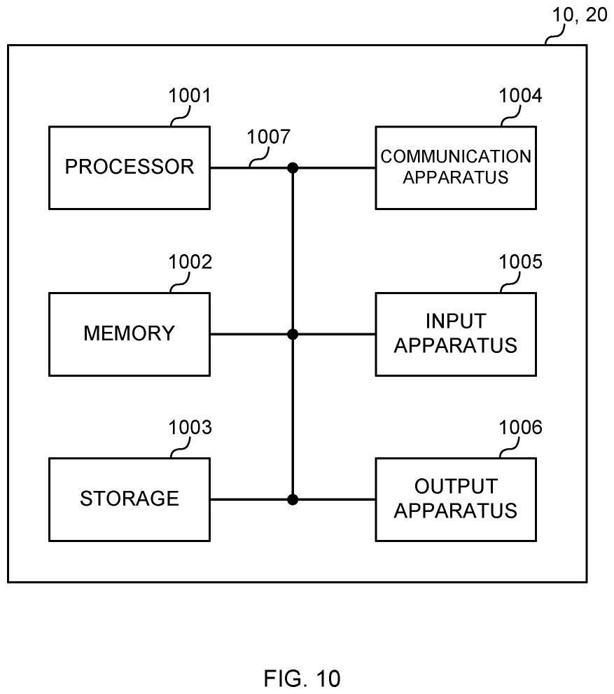

For example, the base station, the user terminal, or the like according to the embodiment of the present disclosure may function as a computer that executes processing a radio communication method in the present disclosure. FIG. 10 is a diagram illustrating an example of a hardware configuration of the base station and user terminal according to an embodiment. Physically, the above-described base station 10 and user terminal 20 may be configured as a computer apparatus that includes a processor 1001, a memory 1002, a storage 1003, a communication apparatus 1004, an input apparatus 1005, an output apparatus 1006, a bus 1007, or the like.

Note that, in the present disclosure, wording such as an apparatus, a circuit, a device, a section, or a unit can be replaced with each other. The hardware configuration of the base station 10 and user terminal 20 may be configured to include one or a plurality of the apparatuses illustrated in the drawings, or may be configured not to include some apparatuses.

For example, although only one processor 1001 is illustrated, a plurality of processors may be provided. Furthermore, processing may be executed by one processor, or processing may be performed in parallel, in sequence, or by using another manner, by two or more processors. Note that the processor 1001 may be implemented with one or more chips.

Each function of the base station 10 and user terminal 20 is implemented by, for example, causing hardware such as the processor 1001 or memory 1002 to read given software (program), so that the processor 1001 operates to control communication via the communication apparatus 1004 or control at least one of reading and writing of data in the memory 1002 or the storage 1003.

The processor 1001 controls an entire computer by, for example, causing an operating system to operate. The processor 1001 may include a Central Processing Unit (CPU) including an interface with peripheral equipment, a control apparatus, an operation apparatus, a register, or the like. For example, at least a part of the above-described control section 110 (210), transmitting/receiving section 120 (220), or the like may be implemented by the processor 1001.

Furthermore, the processor 1001 reads a program (program code), a software module, data, or the like from at least one of the storage 1003 and the communication apparatus 1004 into the memory 1002, and executes various kinds of processing according to these. As the program, a program to cause a computer to execute at least a part of the operation described in the above-described embodiment is used. For example, the control section 110 (210) may be implemented by a control program that is stored in the memory 1002 and operates in the processor 1001, and another functional block may be implemented similarly.

The memory 1002 is a computer-readable recording medium, and may include, for example, at least one of a Read Only Memory (ROM), an Erasable Programmable ROM (EPROM), an Electrically EPROM (EEPROM), a Random Access Memory (RAM), or another appropriate storage medium. The memory 1002 may also be referred to as a register, a cache, a main memory (primary storage apparatus), or the like. The memory 1002 can store a program (program code), a software module, or the like, which is executable for performing the radio communication method according to an embodiment of the present disclosure.

The storage 1003 is a computer-readable recording medium, and may include, for example, at least one of a flexible disk, a floppy (registered trademark) disk, a magneto-optical disk (for example, a compact disc (Compact Disc ROM (CD-ROM), or the like), a digital versatile disc, a Blu-ray (registered trademark) disk, a removable disk, a hard disk drive, a smart card, a flash memory device (for example, a card, a stick, a key drive, or the like), a magnetic stripe, a database, a server, or another appropriate storage medium. The storage 1003 may also be referred to as a secondary storage apparatus.

The communication apparatus 1004 is hardware (transmitting/receiving device) for performing inter-computer communication via at least one of a wired network and a wireless network, and for example, is referred to as a network device, a network controller, a network card, a communication module, or the like. The communication apparatus 1004 may include a high frequency switch, a duplexer, a filter, a frequency synthesizer, or the like in order to implement, for example, at least one of Frequency Division Duplex (FDD) and Time Division Duplex (TDD). For example, the transmitting/receiving section 120 (220), the transmission/reception antenna 130 (230), or the like described above may be implemented by the communication apparatus 1004. The transmitting/receiving section 120 (220) may be implemented by physically or logically separating the transmitting section 120a (220a) and the receiving section 120b (220b) from each other.

The input apparatus 1005 is an input device configured to receive input from outside (for example, a keyboard, a mouse, a microphone, a switch, a button, a sensor, or the like). The output apparatus 1006 is an output device configured to perform output to outside (for example, a display, a speaker, a Light Emitting Diode (LED) lamp, or the like. Note that the input apparatus 1005 and the output apparatus 1006 may be provided in an integrated configuration (for example, a touch panel).

Furthermore, each of the apparatuses, such as the processor 1001, the memory 1002, or the like is connected by the bus 1007 for communication of information. The bus 1007 may include a single bus, or may include different buses between each of the apparatuses.

Furthermore, the base station 10 and the user terminal 20 may include hardware such as a microprocessor, a Digital Signal Processor (DSP), an Application Specific Integrated Circuit (ASIC), a Programmable Logic Device (PLD), a Field Programmable Gate Array (FPGA), or the like, and part or all of each of the functional blocks may be implemented by the hardware. For example, the processor 1001 may be implemented by using at least one of these pieces of hardware.

### (Modifications)

Note that terms described in the present disclosure and terms necessary for understanding the present disclosure may be replaced with other terms that have the same or similar meanings. For example, a channel, a symbol, and a signal (or signaling) may be replaced with one another. Furthermore, the signal may be a message. A reference signal may be abbreviated as an RS, and may also be referred to as a pilot, a pilot signal, or the like, depending on which standard applies. Furthermore, a Component Carrier (CC) may also be referred to as a cell, a frequency carrier, a carrier frequency, or the like.

A radio frame may include one or a plurality of periods (frames) in a time domain. Each of the one or a plurality of periods (frames) that constitute a radio frame may also be referred to as a subframe. Moreover, a subframe may include one or a plurality of slots in a time domain. A subframe may be a fixed time duration (for example, 1 ms) that is not dependent on numerology.

Here, the numerology may be a communication parameter applied to at least one of transmission and reception of a given signal or channel. For example, the numerology may indicate at least one of SubCarrier Spacing (SCS), a bandwidth, symbol duration, a cyclic prefix length, a Transmission Time Interval (TTI), the number of symbols per TTI, a radio frame configuration, specific filtering processing to be performed by a transceiver in a frequency domain, specific windowing processing to be performed by a transceiver in a time domain, or the like.

In the time domain, a slot may include one or a plurality of Orthogonal Frequency Division Multiplexing (OFDM) symbols, Single Carrier Frequency Division Multiple Access (SC-FDMA) symbols, or the like. Furthermore, a slot may be a time unit based on numerology.

A slot may include a plurality of mini slots. Each of the mini slots may include one or a plurality of symbols in a time domain. Furthermore, a mini slot may also be referred to as a subslot. A mini slot may include fewer symbols than slots. A PDSCH (or PUSCH) transmitted in a time unit larger than a time unit of a mini slot may also be referred to as PDSCH (PUSCH) mapping type A. A PDSCH (or PUSCH) transmitted by using a mini slot may also be referred to as PDSCH (PUSCH) mapping type B.

A radio frame, a subframe, a slot, a mini slot and a symbol all represent a time unit in signal transmission. A radio frame, a subframe, a slot, a mini slot, and a symbol may be referred to as respective different names. Note that time units such as a frame, a subframe, a slot, a mini slot, and a symbol in the present disclosure may be replaced with each other.

For example, one subframe may also be referred to as a TTI, a plurality of consecutive subframes may be referred to as a TTI, and one slot or one mini slot may be referred to as a TTI. That is, at least one of a subframe and a TTI may be a subframe (1 ms) in an existing LTE, may be a period shorter than 1 ms (for example, 1 to 13 symbols), and may be a period longer than 1 ms. Note that a unit to represent a TTI may also be referred to as a slot, a mini slot, or the like, instead of a subframe.

Here, a TTI refers to a minimum time unit of scheduling in radio communication, for example. For example, in an LTE system, a base station schedules to allocate, to each user terminal, a radio resource (such as a frequency bandwidth or transmission power that can be used in each user terminal) in TTI units. Note that a definition of a TTI is not limited to this.

The TTI may be a transmission time unit of a channel-encoded data packet (transport blocks), a code block, a codeword, or the like, or may be a processing unit of scheduling, link adaptation, or the like. Note that when a TTI is provided, a time interval (for example, the number of symbols) in which a transport block, a code block, a codeword, or the like is actually mapped may be shorter than the TTI.

Note that, in a case where one slot or one mini slot is referred to as a TTI, one or more TTIs (that is, one or more slots or one or more mini slots) may be a minimum time unit of scheduling. Furthermore, the number of slots (the number of mini slots) included a minimum time unit of the scheduling may be controlled.

A TTI having time duration of 1 ms may also be referred to as a usual TTI (TTI in 3GPP Rel. 8 to 12), a normal TTI, a long TTI, a usual subframe, a normal subframe, a long subframe, a slot, or the like. A TTI shorter than a usual TTI may also be referred to as a shortened TTI, a short TTI, a partial TTI (or a fractional TTI), a shortened subframe, a short subframe, a mini slot, a subslot, a slot, or the like.

Note that a long TTI (for example, a usual TTI, a subframe, or the like) may be replaced with a TTI having time duration exceeding 1 ms, and a short TTI (for example, a shortened TTI, or the like) may be replaced with a TTI having TTI duration less than the TTI duration of the long TTI and 1 ms or longer.

A Resource Block (RB) is a unit of resource allocation in a time domain and a frequency domain, and may include one or a plurality of consecutive subcarriers in the frequency domain. The number of subcarriers included in an RB may be the same regardless of numerology, and may be 12, for example. The number of subcarriers included in an RB may be determined based on numerology.

Furthermore, an RB may include one or a plurality of symbols in a time domain, and may be one slot, one mini slot, one subframe or one TTI in length. One TTI, one subframe, or the like may each include one or a plurality of resource blocks.

Note that one or a plurality of RBs may also be referred to as a physical resource block (Physical RB (PRB), a Sub-Carrier Group (SCG), a Resource Element Group (REG), a PRB pair, an RB pair, or the like.

Furthermore, a Resource block may include one or a plurality of Resource Elements (REs). For example, one RE may be a radio resource domain of one subcarrier and one symbol.

A Bandwidth Part (BWP) (which may also be referred to as a partial bandwidth, or the like) may represent a subset of consecutive common RBs (common resource blocks) for given numerology in a given carrier. Here, the common RBs may be specified by an index of the RBs based on a common reference point of the carrier. A PRB may be defined in a given BWP and numbered in the BWP.

The BWP may include a BWP for a UL (UL BWP) and a BWP for a DL (DL BWP). For the UE, one or a plurality of BWPs may be configured in one carrier.

At least one of configured BWPs may be active, and the UE does not need to assume to transmit or receive a given signal/channel outside of the active BWP. Note that “cell”, “carrier”, or the like in the present disclosure may be replaced with “BWP”.

Note that the structures of radio frames, subframes, slots, mini slots, symbols, or the like described above are merely examples. For example, composition of the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, symbol duration, length of a Cyclic Prefix (CP), or the like can be variously changed.

Furthermore, information, a parameter, or the like described in the present disclosure may be represented in absolute values, represented in relative values with respect to given values, or represented by using another corresponding information. For example, a radio resource may be instructed by a given index.

The names used for parameters, or the like, in the present disclosure are in no respect limiting. Moreover, an equation, or the like using these parameters may differ from an equation, or the like explicitly disclosed in the present disclosure. Because various channels (a Physical Uplink Control Channel (PUCCH), a Physical Downlink Control Channel (PDCCH), or the like) and information elements can be identified by any suitable names, the various names allocated to these individual channels and information elements are in no respect limiting.

The information, signals, and the like described in the present disclosure may be represented by using any one of various different technologies. For example, data, an instruction, a command, information, a signal, a bit, a symbol a chip, or the like, all of which may be referenced throughout the herein-contained description, may be represented by voltage, current, an electromagnetic wave, a magnetic field or particle, an optical field or photon, or any combination of these.

Furthermore, information, a signal, or the like may be output at least one of from a higher layer to a lower layer, and from a lower layer to a higher layer.

Information, a signal, or the like may be input or output via a plurality of network nodes.

Information, a signal, or the like that is input or output may be stored in a specific location (for example, on a memory), or may be managed by using a control table. Information, a signal, or the like to be input or output may be overwritten, updated or appended. Information, a signal, or the like that is output may be deleted. Information, a signal, or the like that is input may be transmitted to another apparatus.

Notification of information is not limited to the aspects or embodiment described in the present disclosure, and may be performed by using another method. For example, notification of information in the present disclosure may be performed by using physical layer signaling (for example, Downlink Control Information (DCI), Uplink Control Information (UCI), higher layer signaling (for example, Radio Resource Control (RRC) signaling, broadcast information (Master Information Block (MIB), System Information Block (SIB), or the like), Medium Access Control (MAC) signaling, another signal, or the like, or a combination of these.

Note that physical layer signaling may also be referred to as Layer 1/Layer 2 (L1/L2) control information (L1/L2 control signals), L1 control information (L1 control signal), or the like. Furthermore, RRC signaling may also be referred to as an RRC message, and may be, for example, an RRC Connection Setup message, an RRC Connection Reconfiguration, or the like. Furthermore, MAC signaling may be notified by using, for example, an MAC Control Element (MAC CE).

Furthermore, notification of given information (for example, notification of information that “X holds”) may not only be explicit, but may be implicit (for example, by not notifying of the information, or by notifying of another information).

Judging may be made by a value represented by one bit (0 or 1), may be made by a boolean value that represents true or false, or may be made by comparison of numerical values (for example, comparison with a given value).

Software, whether referred to as software, firmware, middleware, microcode, or hardware description language, or referred to as another name, should be interpreted broadly, to mean an instruction, instruction set, code, code segment, program code, program, subprogram, software module, application, software application, software package, routine, subroutine, object, executable file, execution thread, procedure, function, or the like.

Furthermore, software, a command, information, or the like may be transmitted or received via a communication medium. For example, in a case where software is transmitted from a website, a server, or another remote source by using at least one of a wired technology (a coaxial cable, an optical fiber cable, a twisted-pair cable, a Digital Subscriber Line (DSL), or the like) and a wireless technology (infrared radiation, a microwave, or the like), at least of the wired technology and the wireless technology is included in definition of the communication medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “Quasi-Co-Location (QCL)”, “Transmission Configuration Indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, “panel”, or the like may be used interchangeably.

In the present disclosure, the terms such as “Base Station (BS)”, “radio base station”, “fixed station”, “NodeB”, “eNodeB (eNB)”, “gNodeB (gNB)”, “access point”, “Transmission Point (TP)”, “Reception Point (RP)”, “Transmission/Reception Point (TRP)”, “panel”, “cell”, “sector”, “cell group”, “carrier”, “component carrier”, or the like may be used interchangeably. A base station may be referred to as a term such as a macro cell, a small cell, a femto cell, a pico cell, or the like.

A base station can include one or a plurality of (for example, three) cells. In a case where a base station includes a plurality of cells, an entire Coverage Area of the base station can be divided into a plurality of smaller areas, and each of the smaller areas can provide a communication service through a base station subsystem (for example, an indoor small base station (Remote Radio Head (RRH))). The term “cell” or “sector” refers to all or part of a Coverage Area of at least one of a base station and base station subsystem that provides a communication service within the coverage.

In the present disclosure, the terms “Mobile Station (MS)”, “user terminal”, “User Equipment (UE)”, “terminal”, or the like may be used interchangeably.

A Mobile Station may be referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or one of some other appropriate terms.

At least one of a base station and a Mobile Station may also be referred to as a transmission apparatus, a reception apparatus, a radio communication apparatus, or the like. Note that at least one of the base station and the Mobile Station may be a device mounted on a moving object, a moving object itself, or the like. The moving object may be a conveyance (for example, a car, an airplane, or the like), an unmanned moving object (for example, a drone, an autonomous car, or the like), or a (manned or unmanned) robot. Note that at least one of the base station or the Mobile Station includes an apparatus that does not necessarily move during communication operation. For example, at least one of the base station and the mobile station may be an Internet of Things (IoT) device such as a sensor.

Furthermore, a base station in the present disclosure may be replaced with a user terminal. For example, each aspect/embodiment of the present disclosure may be applied to a configuration in which communication between the base station and the user terminal is replaced with communication among a plurality of user terminals (which may also be referred to as, for example, Device to Device (D2D), Vehicle-to-Everything (V2X), or the like. In this case, the user terminal 20 may be configured having a function that the above-described base station 10 has. Furthermore, the wording such as “up” and “down” may be replaced with wording corresponding to terminal-to-terminal communication (for example, “side”). For example, an uplink channel, a downlink channel, or the like may be replaced with a side channel.

Similarly, a user terminal in the present disclosure may be replaced with a base station. In this case, the base station 10 may be configured having a function that the above-described user terminal 20 has.

Given operation described in the present disclosure to be performed by a base station may, in some cases, be performed by an upper node. In a network including one or a plurality of network nodes with base stations, it is obvious that various operations for communication with terminals are performed by a base station, one or more network nodes (which may be, but not limited to, Mobility Management Entities (MMEs), Serving-Gateways (S-GWs), or the like, for example) or a combination of these.

Each of the aspects and embodiment in the present disclosure may be used individually or in combination, or may be switched depending on execution. Furthermore, a processing procedure, a sequence, a flowchart, or the like of the aspects and embodiment in the present disclosure may be changed as long as inconsistencies do not arise. For example, for the methods described in the present disclosure, elements of various steps are presented by using an exemplary order, and are not limited to the presented specific order.

The aspects and embodiment in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New Radio Access Technology (New-RAT), New Radio (NR), New radio access (NX), Future generation radio access (FX), Global System for Mobile communications (GSM; registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), a system that uses another appropriate radio communication method, a next generation system extended based on these, or the like. Furthermore, a plurality of systems may be applied in combination (for example, a combination of LTE or LTE-A with 5G, or the like).

The phrase “on the basis of” used in the present disclosure does not mean “on the only basis of”, unless otherwise specified. In other words, the phrase “on the basis of” means both “on the only basis of” and “at least on the basis of”.

Any reference to the elements with a designation such as “first”, “second”, or the like used in the present disclosure does not generally limit the number, quantity, or order of the elements. These designations may be used in the present disclosure only for convenience, as a method for distinguishing between two or more elements. Therefore, reference to the first and second elements does not mean that only two elements may be adopted, or that the first element must precede the second element in some way.

The terms “determining” used in the present disclosure may include a wide variety of operations. For example, “determining” may be interpreted to mean “determining” operation of judging, calculating, computing, processing, deriving, investigating, looking up, searching, inquiring (for example, looking up in a table, database, or another data structure), confirming, or the like.

Furthermore, “determining” may be interpreted to mean “determining” operation of receiving (for example, receiving information), transmitting (for example, transmitting information), inputting, outputting, accessing (for example, accessing data in a memory), or the like.

Furthermore, “determining” may be interpreted to mean “determining” operation of resolving, selecting, choosing, establishing, comparing, or the like. In other words, “determining” may be interpreted to mean “determining” some operation.

Furthermore, “determining” may be replaced with “assuming”, “expecting”, “considering”, or the like.

The terms “connected”, “coupled”, or any variation of these terms used in the present disclosure mean all direct or indirect connection or coupling between two or more elements, and may include presence of one or more intermediate elements between the two elements that are “connected” or “coupled” to each other. Coupling or connection between the elements may be physical, logical or a combination of these. For example, “connection” may be replaced with “access”.

In a case where two elements are connected in the present disclosure, these elements may be considered to be “connected” or “coupled” to each other by using one or more electrical wires, cables, printed electrical connections, or the like, or, as non-limiting and non-inclusive examples, by using electromagnetic energy having a wavelength in a radio frequency domain, microwave domain, or optical (both visible and invisible) domain, or the like.

In the present disclosure, the phrase “A and B are different” may mean “A and B are different from each other”. Note that the term may mean that “A and B are respectively different from C”. The terms such as “leave” “coupled” or the like may be interpreted similarly as “different”.

In a case where terms such as “include”, “including”, or a variation of these are used in the present disclosure, these terms are intended to be inclusive similarly to a case where “comprising” is used. Moreover, the term “or” used in the present disclosure is intended to be not an exclusive-OR.

In the present disclosure, for example, a case where an article, such as “a”, “an”, or “the” is added in English translation may be interpreted that a noun that follows the article may be plural.

Although the invention according to the present disclosure has been described in detail above, it is obvious for a person skilled in the art that the invention according to the present disclosure is by no means limited to the embodiments described in the present disclosure. The invention according to the present disclosure can be implemented with correction or modification, without departing from the spirit or scope of the invention defined by the claims. Therefore, description of the present disclosure is provided for the purpose of exemplification and explanation, and is by no means a limitation to the invention according to the present disclosure.

1. A user terminal comprising:
a transmitting section that transmits a Uplink Shared Channel by using a resource used for configured grant-based UL transmission; and
a control section that cancels transmission of a configured grant-based Uplink Shared Channel using the resource in units of a given frequency domain based on information instructed by Downlink Control Information.

2. The user terminal according to claim 1, wherein information specified in the Downlink Control Information is information indicating a slot format in a time domain.

3. The user terminal according to claim 1, wherein at least one of a position and size of the given frequency domain is configured based on at least one of for each Band Width Part (BWP), for each cell, and for each user terminal.

4. The user terminal according to claim 3, wherein, in a case where at least one of a position and size of the given frequency domain is configured for each the BWP, the control section applies a position and size of a given frequency domain configured to a changed BWP according to a change in the BWP.

5. The user terminal according to claim 3, wherein, in a case where at least one of a position and size of the given frequency domain is configured for each the cell, the control section applies a position and size of a frequency domain common between before and after a change in the BWP.

6. A radio communication method comprising, in a user terminal:
transmitting a Uplink Shared Channel by using a resource used for configured grant-based UL transmission; and
canceling transmission of a configured grant-based Uplink Shared Channel using the resource in units of a given frequency domain based on information instructed by Downlink Control Information.

7. The user terminal according to claim 2, wherein at least one of a position and size of the given frequency domain is configured based on at least one of for each Band Width Part (BWP), for each cell, and for each user terminal.
